(19) United States
(12) Patent Application Publication
(10) Pub. No.: US 2013/0062895 A1
(43) Pub. Date: Mar. 14, 2013

(54) PET WASTE COLLECTION APPARATUS FOR SUPPORTING A HANDLED PLASTIC BAG THEREON, AND METHOD OF USING SAME

(71) Applicants: Daniel J. GROTH, ST. CLAIR SHORES, MI (US); Frank R. GROTH, ST. CLAIR SHORES, MI (US); Brian M. GROTH, ST. CLAIR SHORES, MI (US)

(72) Inventors: Daniel J. GROTH, ST. CLAIR SHORES, MI (US); Frank R. GROTH, ST. CLAIR SHORES, MI (US); Brian M. GROTH, ST. CLAIR SHORES, MI (US)

(21) Appl. No.: 13/411,327

(22) Filed: Mar. 2, 2012

Related U.S. Application Data
(60) Provisional application No. 61/448,863, filed on Mar. 3, 2011.

(51) Int. Cl. A01K 29/00

(52) U.S. Cl. CPC A01K 29/00
USPC 294/1.3

(57) ABSTRACT

A pet waste collection apparatus includes a main frame body including a loop portion, a frame handle attached to the loop portion, and a pair of opposed hooks extending outwardly from the frame handle near an area thereof where it attaches to the loop portion. The main frame body may be formed from solid or coated wire. In use, bag handles of a disposable handled bag are placed over the hooks, and the upper edge of the main bag body is then placed over the loop portion where it fits tightly. The bottom portion of the bag is then fed through the loop portion, and a unit of pet waste is moved through the loop portion and into the plastic bag.

### CROSS-REFERENCE TO RELATED APPLICATIONS

The present application claims priority under 35 USC 119 based on U.S. Provisional patent application No. 61/448,863, filed on Mar. 3, 2011. The entire subject matter of this priority document, including specification claims and drawings thereof, is incorporated by reference herein.

### BACKGROUND OF THE INVENTION

1. Field of the Invention

The present invention relates to a pet waste collection apparatus. More particularly, the present invention relates to a portable frame apparatus, for use with a disposable handled plastic bag thereon to pick up pet waste in an outdoor environment, and to a method of using the frame apparatus.

2. Description of the Background Art

Pets, such as dogs and cats, are very popular. Many dog owners, in particular, are in the habit of taking their dogs on one or more walks every day. It is common for a dog to relieve him or herself during these daily walks, and responsible pet owners clean up after their dogs expel solid waste. However, it is well known that pet waste may contain pathogenic microorganisms such as bacteria or other harmful microfauna.

It has become quite common for many retail stores to give away handled plastic bags such as the bag B shown in FIG. 1B, to their customers. Pet owners often carry plastic bags along on such dog walks for the purpose of picking up solid pet waste. While such bags are useful, manually manipulating a bag may be somewhat difficult or tricky. In addition, there is some risk that this type of bag may have a hole in it, which may cause the pet owner to inadvertently come into direct contact with pet waste during pickup.

A number of different devices are known for collecting and disposing of pet waste. Examples of some of the known devices include those described in Lachance, U.S. Pat. No. 4,103,953, Greenhut, U.S. Pat. No. 4,718,707, Heinrichson, U.S. Pat. No. 5,350,208, Peck et al., U.S. Pat. No. 5,400,572, Albert, U.S. Pat. No. 5,540,469, Franks, U.S. Pat. No. 6,012,748, Wynn, U.S. Pat. No. 6,113,166, Kelly et al., U.S. Pat. No. 6,554,335, Mendez, U.S. Pat. No. 6,942,264, Bielak, U.S. Pat. No. 7,431,360, Diehl, US Published Patent Application 2004-0164568, Diehl, US Published Patent Application 2009-0058114, and Colaiano, US Published Patent Application 2009-0079211.

Although the known devices have some utility for their intended purposes, a need still exists in the art for a simple, relatively inexpensive and portable pet waste collection apparatus. In particular, there is a need for an inexpensive pet waste collection apparatus which will work with the freely available handled plastic shopping bags which are in common use today.

### SUMMARY OF THE INVENTION

Accordingly, it is an object of the present invention to provide an inexpensive pet waste collection apparatus which will work with handled plastic shopping bags.

It is another object of the invention to provide a pet waste collection apparatus which can be easily stored in a small space.

It is yet another object of the invention to provide a pet waste collection apparatus which will protect a user thereof from contamination by avoiding direct contact with pet waste during use thereof.

In an illustrative embodiment hereof, a pet waste collection apparatus includes a main frame body including a loop portion, a frame handle attached to the loop portion, and a pair of opposed hooks extending outwardly from the frame handle near an area thereof where it attaches to the loop portion. Optionally, the main frame body may be formed from a strong plastic material. Alternatively, the main frame body may be formed from solid or coated wire.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1A is a perspective view of a pet waste collection apparatus according to a first illustrative embodiment of the present invention.

FIG. 1B is a perspective view of a disposable plastic bag which is mountable on the apparatus of FIG. 1A.

FIG. 1C is a cross-sectional view of a portion of the apparatus of FIG. 1A, taken along the line C-C therein.

FIG. 2 is a front end view of the apparatus of FIG. 1A.

FIG. 3 is a top plan view of the apparatus of FIG. 1A, the bottom view being substantially identical;

FIG. 4 is a right side view of the apparatus of FIG. 1A, the left side view being substantially a mirror image thereof;

FIG. 5 is a rear end view of the apparatus of FIG. 1A; and

FIG. 6 is a perspective view of the apparatus of FIG. 1A with the bag mounted thereon and shown in phantom.

FIG. 7 is an exploded perspective view of a pet waste collection apparatus according to a second illustrative embodiment of the present invention.

FIG. 8 is a top plan view of a of a pet waste collection apparatus according to a third illustrative embodiment of the present invention.

FIG. 9 is a top plan view of a pet waste collection apparatus according to a fourth illustrative embodiment of the present invention.

FIG. 10 is a simplified block diagram showing steps in an illustrative method according to the present invention.

FIGS. 11A-11D illustrate stages of mounting/attaching a bag to the collection apparatus of the present invention.

### DETAILED DESCRIPTION OF ILLUSTRATIVE EMBODIMENTS

Descriptions are provided below of selected illustrative embodiments of the present invention as examples of the present invention, supported by and shown in the accompanying drawings. It should be understood that only structures considered necessary for clarifying the present invention are described herein. Other conventional structures, and those of ancillary and auxiliary components hereof, will be known and understood by those in the art.

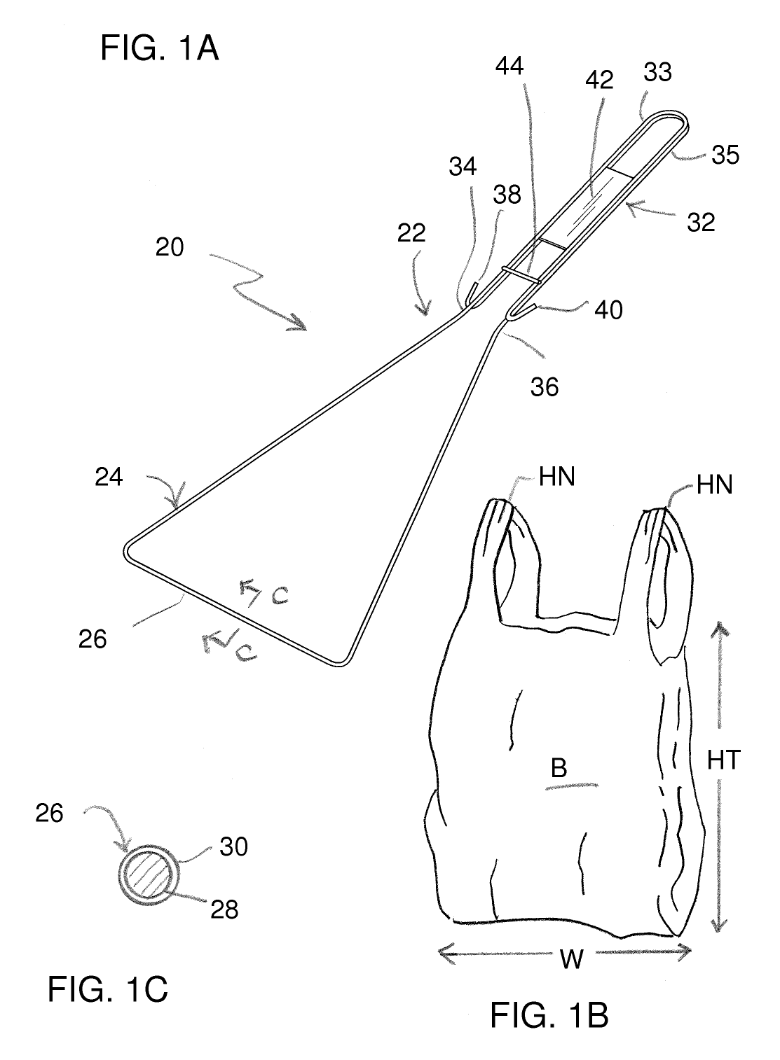

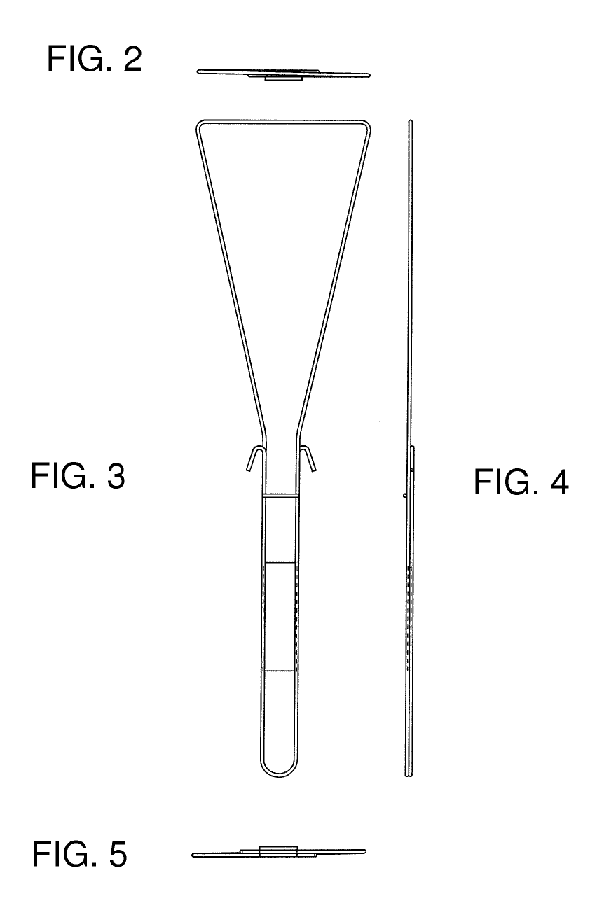

Referring now to the drawings, a pet waste collection apparatus according to an illustrative embodiment of the present invention is shown generally at 20 in FIG. 1A, with a handled plastic bag B shown separately in FIG. 1B. The pet waste collection apparatus 20 is usable with a plastic bag B mounted thereon for picking up solid pet waste.

It should be understood that, although the apparatus 20 is intended for use with a handled plastic shopping bag B of a type which is commonly available today, the bag B is conventional, and does not form a part of the present invention, per se. Since this type of bag is given away by many commercial establishments, these bags B are commonly available and are easily acquired. The bag B has a bag body with a width W of about 11-12 inches, and a height HT of about 14-16 inches, with the bag handles HN adding about four inches of additional height to the bag body.

The pet waste collection apparatus includes a main frame body 22, which may be formed from solid or plastic-coated wire material which is sufficiently rigid to hold its shape over time. The main frame body 22 may be bent into shape on a wire-bending machine (not shown) when such wire material is used.

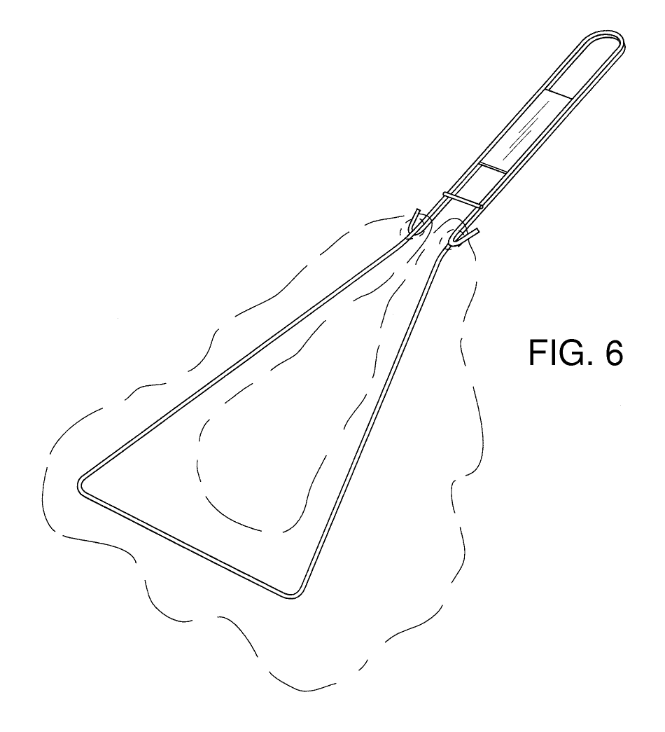

Alternatively, the main frame body 22 may be cast out of a resilient, durable and strong plastic material. The main frame body is configured and dimensioned to supportively receive a handled plastic bag B thereon, with bag handles HN of the plastic bag placed over the hooks of the main frame body, as shown in FIG. 6.

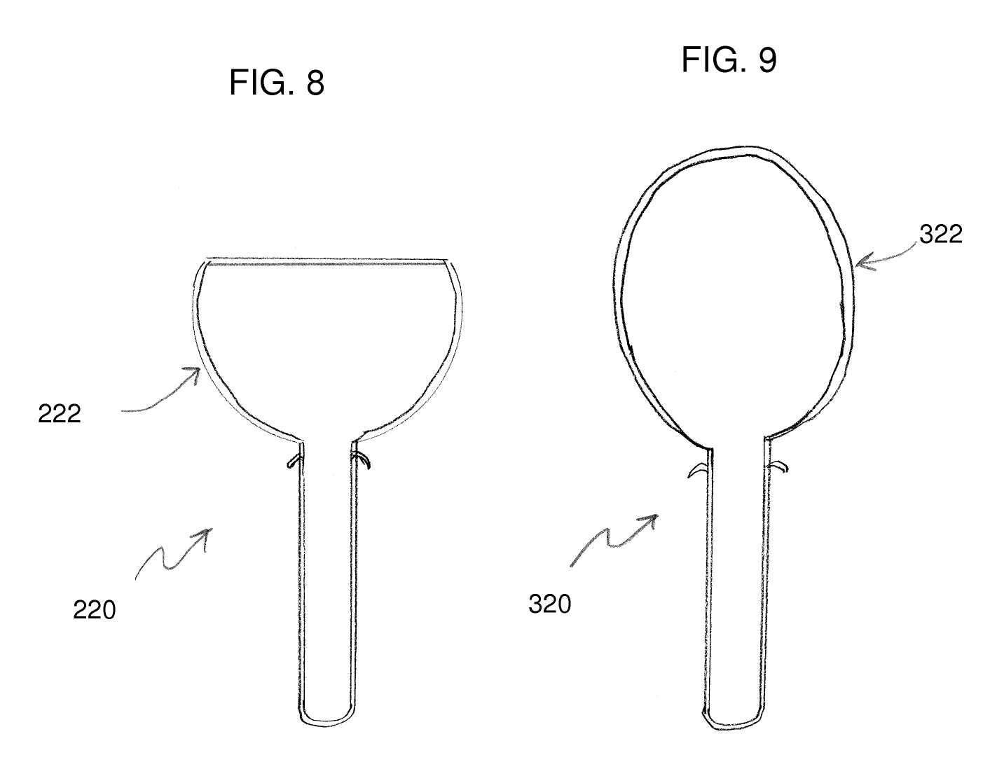

The main frame body 22 includes a loop portion 24 for supporting the bag body thereon. The loop portion 24 may be formed in a generally triangular shape, as shown. Alternatively, the loop portion 24 may be substantially circular (FIG. 9) or may be partially circular with a flattened outer edge portion (FIG. 8). The loop portion 24 may include a generally straight distal edge segment 26 for placement abutting the ground during use.

FIG. 1C illustrates a cross-sectional view of the loop portion 26, taken along the line C-C in FIG. 1 and showing a central wire core 28 and a plastic coating 30, which may be vinyl, plastisol or the like. If desired, the entire main frame body 22 may have this coated wire construction.

The main frame body 22 also includes a frame handle 32 integrally attached to the loop portion at two spaced apart connection points 34, 36. Where the apparatus 20 is formed of wire, the frame handle 32 may be formed of the same wire material as the loop portion 24. The frame handle 32 may, optionally, include two stacked wire sections 33, 35 arranged in close proximity to one another, and if desired, the collection apparatus 20 may also include an optional reinforcing handle plate 42 disposed between the wire sections 33, 35 of the frame handle, as shown.

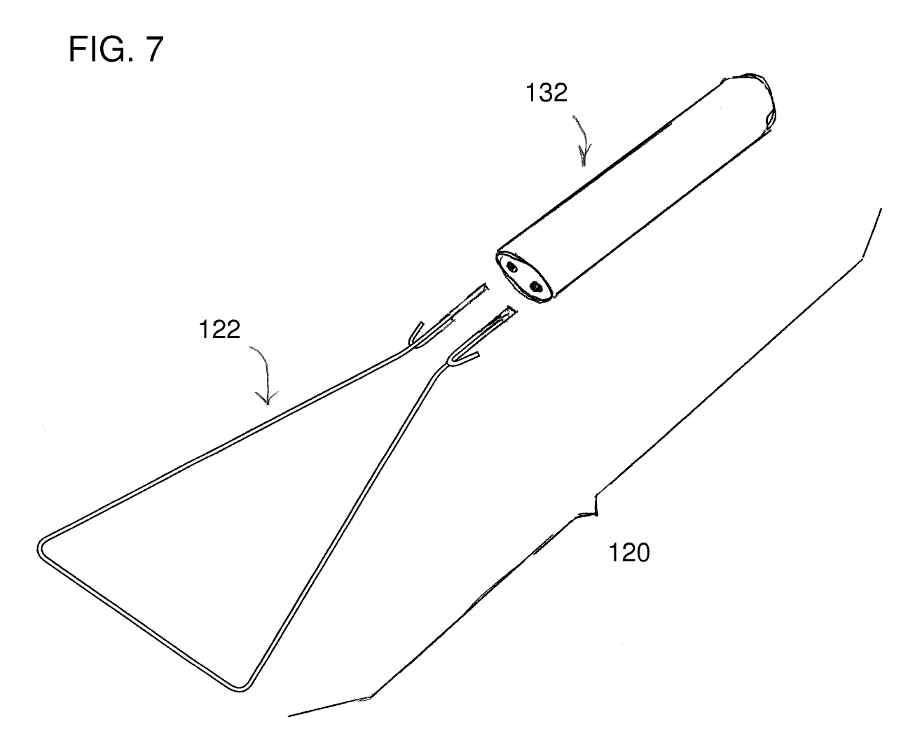

Alternatively, in a second embodiment of the apparatus 120, as shown in FIG. 7, the frame handle 132 may be cylindrical in shape, may be formed separately from the main frame body 122, and may be formed from wood, plastic or metal. Other shapes besides cylindrical may also be used, if preferred, such as rectangular or having an oval or geometric cross-section.

The main frame body 22 also includes a pair of hooks 38, 40 respectively attached to and extending outwardly from the frame handle 32 proximate the connection points 34, 36 between the frame handle and the loop portion, as shown. The hooks generally are opposed to one another, and are provided to receive handle bags HN thereon.

The main frame body 22 is configured and dimensioned to supportively receive a handled plastic bag B thereon with the bag handles HN of the plastic bag placed over the hooks 38, 40 of the main frame body, respectively.

Optionally, but not necessarily, the main frame body 22 may include a crossmember 44 attached to, and extending across the frame handle 32 proximate the hooks 38, 40.

In the first depicted embodiment, the collection apparatus 20 is substantially flat, and can easily be hung on a hook and/or stored against a wall or in a drawer.

In use, the bag handles HN of a disposable bag B are placed over the hooks 38, 40 and the upper edge of the main bag body is then placed or stretched over and around the loop portion 24, where it fits tightly. The bottom portion of the bag B is then fed through the loop portion 24, and the loop portion may then be placed against the ground surface and dragged therealong, to catch pet waste up inside of the bag. Alternatively or concurrently, a stick or branch may be used to push the pet waste through the loop member and into the bag B. In this process, the pet waste contacts only surfaces of the bag B, and does not directly come into contact with the collection apparatus 20. This means that the apparatus 20 should not be contaminated by any direct contact, and therefore should not require cleaning between uses.

The filled bag B is then removed from the apparatus 20 and discarded, and is replaced with a fresh bag before the next use of the apparatus.

The method of using the apparatus 20 will now be described in slightly more detail.

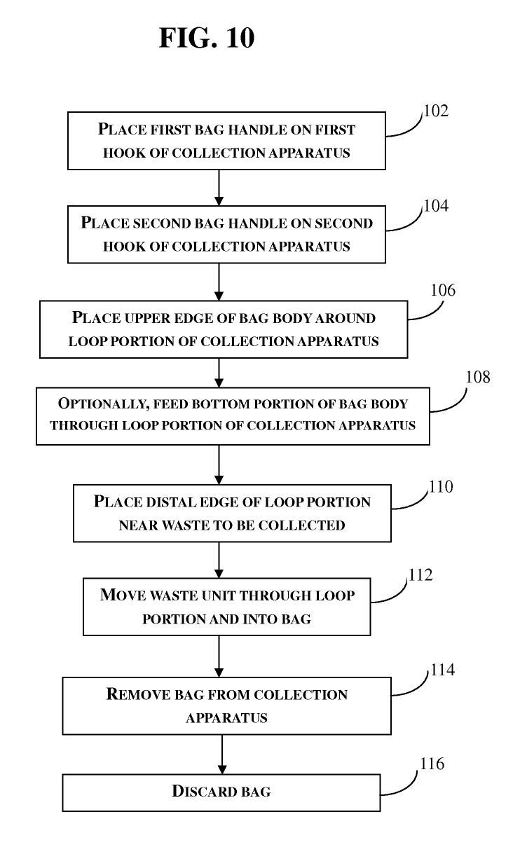

A method of picking up pet waste according to the present invention includes a first step of placing a first bag handle HN of a handled plastic bag B on a first hook 38 of the frame apparatus 20 as previously described herein. This step is shown at 102 in the diagram of FIG. 10.

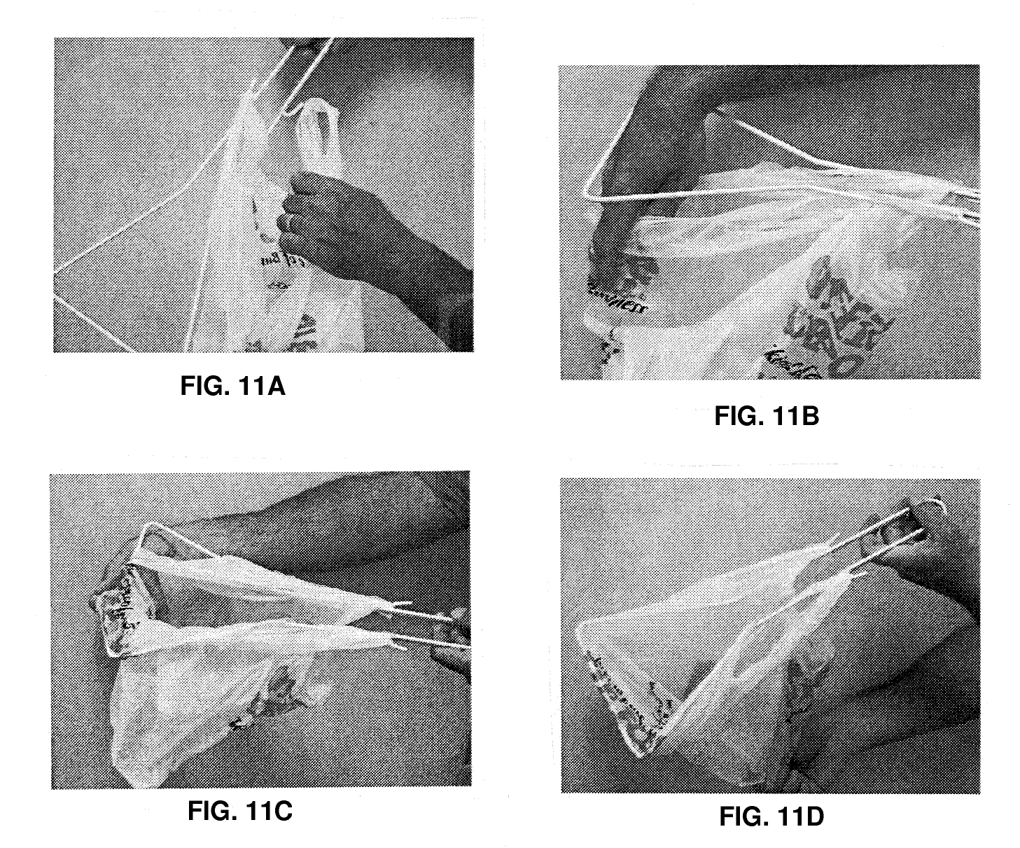

The method hereof also includes a step of placing a second bag handle HN of the handled plastic bag B on a second hook 40 of the frame apparatus 20, where the second hook is located proximate the first hook 38. This step is shown at 104 in the diagram of FIG. 10 and FIG. 11A.

As described above, the frame apparatus 20 also includes a frame handle portion 32 and a loop portion 24, which is attached to the frame handle.

The method hereof also includes a step of placing an upper edge of a main bag body of the plastic bag over the loop portion 24 of the collection apparatus 20. This step is shown at 106 in the diagram of FIG. 10, and FIGS. 11B-11C.

The method hereof also includes an optional step of feeding a bottom portion of the handled plastic bag through the loop portion of the frame apparatus. This step is shown at 108 in the diagram of FIG. 10.

The bag shown in mounted on the collection apparatus 20, and ready for use, in FIG. 11D.

Optionally, the method hereof may include a step of placing a distal edge portion 26 of the collection apparatus 20 abutting the ground in an area proximate a unit of pet waste to be collected. This step is shown at 110 in the diagram of FIG. 10.

The method hereof also includes a step of moving a unit of pet waste over the distal edge portion 26 and through the loop portion 24, thereby placing the waste unit into the plastic bag B. This step is shown at 112 in the diagram of FIG. 10.

The method hereof also includes a step of removing the bag B from the frame apparatus 20. This step is shown at 114 in the diagram of FIG. 10.

Optionally, the method may include a further step of discarding the bag B. This step is shown at 116 in the diagram of FIG. 10.

The sequence of the method steps illustrated in FIG. 10 may be varied without departing from the scope of the method of using pet waste collection apparatus of the present invention.

Although the present invention has been described herein with respect to specific illustrative embodiments, the foregoing description is intended to illustrate, rather than to limit the invention. Those skilled in the art will realize that many modifications of the illustrative embodiments could be made which would be operable.

What is claimed is:

1. A frame apparatus usable with a handled plastic bag for picking up waste, said frame apparatus comprising a main frame body comprising:
a loop portion;
a frame handle portion operatively attached to the loop portion at two spaced apart connection points; and
a pair of hooks respectively attached to and extending outwardly from the frame handle portion proximate said connection points;
whereby the main frame body is configured and dimensioned to supportively receive a handled plastic bag thereon with bag handles of the plastic bag placed over the hooks of the main frame body.

2. The frame apparatus of claim 1, wherein the frame further comprises a crossmember attached to and extending across the frame handle proximate said hooks.

3. The frame apparatus of claim 1, wherein the main frame body is formed of wire.

4. The frame apparatus of claim 3, wherein the wire is coated with a plastic material.

5. The frame apparatus of claim 1, wherein the frame handle comprises two wire sections arranged in close proximity to one another, and further comprising a reinforcing plate disposed between said wire sections of said frame handle.

6. The frame apparatus of claim 3, wherein the frame further comprises a crossmember attached to and extending across the frame handle proximate said hooks.

7. The frame apparatus of claim 1, wherein the apparatus is substantially flat.

8. The frame apparatus of claim 1, wherein the main frame body is formed of wire, and wherein the frame handle is formed separately from the main frame body.

9. A method of picking up pet waste, said method comprising the steps of:
a) placing a first bag handle of a handled plastic bag on a first hook of a frame apparatus;
b) placing a second bag handle of the handled plastic bag on a second hook of the frame apparatus, where said second hook is located proximate said first hook, said frame apparatus further comprising a frame handle portion and a loop portion which is attached to the frame handle;
c) placing an upper edge of a main bag body of the plastic bag over the loop portion;
d) optionally, feeding a bottom portion of the handled plastic bag through the loop portion of the frame apparatus;
e) moving a unit of pet waste through the loop portion and into the plastic bag; and
f) removing the bag from the frame apparatus.
